(19) United States
(12) Patent Application Publication
(10) Pub. No.: US 2025/0256316 A1
(43) Pub. Date: Aug. 14, 2025

(54) BEARING TEMPERATURE REDUCTION THROUGH SLEEVE MODIFICATION

(71) Applicant: Primetals Technologies USA LLC, Alpharetta, GA (US)

(72) Inventors: Thomas C. Wojtkowski, JR., Sutton, MA (US); Kenneth R. Scheffler, Dudley, MA (US); Peter N. Osgood, Westborough, MA (US); Ian Gow, Worcester, MA (US); Earl S. Winslow, JR., Grafton, MA (US)

(73) Assignee: Primetals Technologies USA LLC, Alpharetta, GA (US)

(21) Appl. No.: 18/856,994

(22) PCT Filed: Apr. 13, 2023
(86) PCT No.: PCT/US2023/018406

§ 371 Date: Oct. 15, 2024

(30) Foreign Application Priority Data
Apr. 20, 2022 (WO) PCT/US2022/025535

(51) Int. Cl. B21B 31/07

(52) U.S. Cl. CPC B21B 31/076

(57) ABSTRACT

A novel sleeve is disclosed as used in a roll in a rolling mill, where a feature of length l is introduced on the tapered end of the inboard portion of an inner surface of the sleeve, where the introduced feature allows the sleeve to deflect as load increases at a maximum radial deflection of δ. The introduced feature deals with elevated temperatures on the inboard side of the sleeve by allowing the sleeve to deflect as the load increases.

### BACKGROUND OF THE INVENTION

### Field of Invention

The present invention relates generally to the field of rolling mill back-up bearings, particularly oil film back-up bearings. More specifically, the present invention is related to the improvement of the temperature profile within the bearings during operation.

### Discussion of Related Art

FIGS. 1A-B depict a known oil film bearing assembly as described in U.S. Pat. No. 4,772,137. The standard in the industry is a cylindrical bushing (sometimes known as the bearing) and a cylindrical outer diameter/tapered inner diameter sleeve (sometimes known as the journal). The bushing has a close fit cylindrical outside diameter within the chock (the bearing housing) and the sleeve has an inner taper angle that exactly matches the roll.

The '137 patent describes atypical rolling mill oil film bearing as follows. The roll 10 has a neck section 12. The neck section 12 may be conical, as shown in FIG. 1(A), or it may be cylindrical in some alternate configurations. A sleeve 14 is received on and fixed relative to the neck section 12. The exterior of the sleeve defines the journal surface 16 of the roll neck. A bushing 18 has an internal bearing surface 20 surrounding and rotatably supporting the journal surface 16. The bushing is contained by and fixed within a chock 22. The chock is closed at the outboard end by an end plate 24 and cover 26. A seal assembly 28 is provided between the roll and the inboard end of the chock 22.

During normal operation of the mill, when the roll is rotating at adequate speeds for full hydrodynamic operation, a continuous flow of oil is fed through one of the sets of passageways 29 in the chock, feed openings 30 in the bushing and rebores 32 in the bearing surface 20. From here, the oil enters between the bearing surface 20 and the rotating journal surface 16 to form a hydrodynamically maintained somewhat wedge-shaped oil film 34 by the bearing load zone “Z” and the hydrodynamic length “L_{H}”, the length of the bushing that interacts with the sleeve and supports the oil film. In FIG. 1(A), the load is applied through the roll at “SF”. The load is resisted by a force on the chock “F”. The load zone is located on the same side as the resisting force “F”. The pressure profile at the load zone is schematically depicted in FIG. 1(A) at “P”.

Conventional hydrostatic means are employed to create the necessary oil film between the journal and bearing surfaces when the roll is either not rotating or rotating at a speed slower than that required to create and maintain the hydrodynamic oil film 34.

Oil is continuously drained from between the journal and bearing surfaces 16, 20 at both the inboard and outboard ends of the load zone. The oil draining from the inboard end enters an inboard sump 36 enclosed by the seal assembly 28 and the adjacent surfaces of the chock, bushing and roll. Oil draining from the outboard end enters an outboard sump 38 enclosed by the end plate 24 and chock 22. The sumps 36, 38 are interconnected by one or more passageways 40 drilled through the chock, and the outboard sump 38 is connected to a conventional lubrication system (not shown) which filters, cools and recirculates the oil back to the bearing for reintroduction between the bearing and journal surfaces 16, 20.

A conventional sleeve as used on a roll in a rolling mill is shown at 300 in FIG. 3(A). The sleeve having an inboard end 301 and an outboard end 302, the sleeve comprising: (a) an outer surface 303 shaped like a cylinder having a sleeve length L_{S} and diameter OD with a portion of the sleeve length generating the oil film designated as the hydrodynamic length L_{H}, (b) an inner surface 304 shaped like a cone comprised of an inside diameter ID at the inboard end and a standard taper angle a. The inner surface 304 can also be alternately shaped like a cylinder in some alternate configurations.

Embodiments of the present invention are an improvement over prior art systems and methods.

### SUMMARY OF THE INVENTION

In one embodiment, FIG. 3B option 1, the present invention provides a sleeve as used in a roll in a rolling mill, the sleeve having an inboard end and an outboard end, the sleeve comprising: (a) an outer surface shaped like a cylinder having sleeve length L_{S}, hydrodynamic length L_{H}, and outside diameter OD, and (b) an inner surface having an inside diameter ID at the inboard end and a taper angle α, the inner surface comprising: (1) a first portion of length (L_{S}−l), the first portion conically shaped having a first ramp portion; and (2) a second portion of length l, the second portion comprising: (i) an undercut portion having an undercut radius, r, the undercut portion located adjacent to an end of the first portion that is proximate to the inboard end; (ii) a second ramp portion located adjacent to the undercut portion, and wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of [symbol] is defined as b*Hydrodynamic Length {L_{H}}, wherein b is picked to be within the range 20%≤b≤35% with b preferable 25%. In the same embodiment, length (L_{S}−l)>length l. In the same embodiment, the undercut radius r is defined as c*length l wherein c, is picked to be in the range 2%≤c≤10% with c preferable 5%.

In another embodiment, FIG. 3B option 2, the present invention provides a sleeve as used in a roll in a rolling mill, the sleeve having an inboard end and an outboard end, the sleeve comprising: (a) an outer surface shaped like a cylinder having sleeve length L_{S}, hydrodynamic length L_{H} and outside diameter OD; and (b) an inner surface having an inside diameter ID at the inboard end and a taper angle α, the inner surface comprising: (1) a first portion of length (L_{S}−l), the first portion conically shaped having a first ramp portion; and (2) a second portion of length l, wherein the second portion comprises an undercut radius, r, wherein a full length [symbol] of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−)>length l. In the same embodiment, the undercut radius r is defined as c*length l wherein c, is picked to be in the range 2%≤c≤10% with c preferable 5%.

In yet another embodiment, FIG. 3(C) option 1, the present invention provides a sleeve as used in a roll in a rolling mill, the sleeve having an inboard end and an outboard end, the sleeve comprising: (a) an outer surface shaped like a cylinder having sleeve length L_{S}, hydrodynamic length L_{H}, and outside diameter OD; (b) an inner surface having of an inside diameter ID at the inboard end and a taper angle α, the inner surface comprising: (1) a first portion of length (L_{S}−/), the first portion conically shaped having a first ramp portion; and (2) a second portion of length l, the second portion comprising a second ramp portion located adjacent to the first ramp portion, wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of [symbol] is defined as b*Hydrodynamic Length {L_{H}}, wherein b is picked to be within the range 20%≤b≤35% with b preferable 25%. In the same embodiment, length (L_{S}−)>length l.

In another embodiment, FIG. 3(C) option 2, the present invention provides a sleeve as used in a roll in a rolling mill, the sleeve having an inboard end and an outboard end, the sleeve comprising: (a) an outer surface shaped like a cylinder having sleeve length L_{S}, a hydrodynamic length L_{H}, and outside diameter OD; (b) an inner surface having of an inside diameter ID at the inboard end and a taper angle α, the inner surface comprising: (1) a first portion of length (L_{S}−), the first portion conically shaped having a first ramp portion; and (2) a second portion of length l, wherein a full length l of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−>length l.

In yet another embodiment, FIG. 3(B) option 1, the present invention provides a method for lowering temperature build-up on an inboard side of a sleeve, the sleeve used in a roll in a rolling mill, the sleeve having an inboard end and an outboard end, the method comprising: (a) provisioning an outer surface shaped like a cylinder having sleeve length L_{S}, outer diameter OD, and hydrodynamic length L_{H}; and (b) provisioning an inner surface comprising: (1) a first portion of length (L_{S}−l), the first portion conically shaped having a first ramp portion; and (2) a second portion of length l, the second portion comprising: (i) an undercut portion having an undercut radius, r, the undercut portion located adjacent to an end of the first portion that is proximate to the inboard end; (ii) a second ramp portion located adjacent to the undercut portion, and wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a, is picked to be in the range 0.02≤a≤0.04 with a preferable 0.025. In the same embodiment, a value of [symbol] is defined as b*Hydrodynamic Length {L_{H}}, wherein b is picked to be within the range 20%≤b≤35% with b preferable 25%. In the same embodiment, length (L_{S}−)>length l. In the same embodiment, the undercut radius, r, is defined as c*length l wherein c, is picked to be in the range 2%≤c≤10% with c preferable 5%.

In another embodiment, FIG. 3(B) option 2, the present invention provides a method for lowering temperature build-up on an inboard side of a sleeve, the sleeve used in a roll in a rolling mill, the sleeve having an inboard end and an outboard end, the method comprising: (a) provisioning an outer surface shaped like a cylinder having sleeve length L_{S}, hydrodynamic length L_{H} and outside diameter OD; and (b) provisioning an inner surface having of an inside diameter ID at the inboard end and a taper angle α, the inner surface comprising: (1) a first portion of length (L_{S}−l), the first portion conically shaped having a first ramp portion; and (2) a second portion of length l, wherein the second portion comprises an undercut radius, r, wherein a full length [symbol] of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−)>length l. In the same embodiment, the undercut radius r is defined as c*length l wherein c, is picked to be in the range 2%≤c≤10% with c preferable 5%.

In yet another embodiment, FIG. 3(C) option 1, the present invention provides a method for lowering temperature build-up on an inboard side of a sleeve, the sleeve used in a roll in a rolling mill, the sleeve having an inboard end and an outboard end, the method comprising: (a) an outer surface shaped like a cylinder having sleeve length L_{S}, hydrodynamic length L_{H}, and outside diameter OD; (b) an inner surface having of an inside diameter ID at the inboard end and a taper angle α, the inner surface comprising: (1) a first portion of length (L_{S}−l), the first portion conically shaped having a first ramp portion; and (2) a second portion of length l, the second portion comprising a second ramp portion located adjacent to the first ramp portion, wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of [symbol] is defined as b*Hydrodynamic Length {L_{H}}, wherein b is picked to be within the range 20%≤b≤35% with b preferable 25%. In the same embodiment, length (L_{S}−)>length l.

In another embodiment, FIG. 3(C) option 2, the present invention provides a method for lowering temperature build-up on an inboard side of a sleeve, the sleeve used in a roll in a rolling mill, the sleeve having an inboard end and an outboard end, the method comprising: (a) provisioning an outer surface shaped like a cylinder having sleeve length L_{S}, a hydrodynamic length L_{H}, and outside diameter OD; (b) provisioning an inner surface having of an inside diameter ID at the inboard end and a taper angle α, the inner surface comprising: (1) a first portion of length (L_{S}−), the first portion conically shaped having a first ramp portion; and (2) a second portion of length l, wherein a full length l of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−>length l.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIGS. 1(A)-(B) depict a known hydrodynamic bearing assembly.

FIGS. 2(A)-(C) depict temperature distribution on the sleeve and bushing at the indicated load/speed combinations.

FIGS. 3(A)-(C) depict a standard sleeve and then illustrate several embodiments of the present invention depicting features that are added to the sleeve.

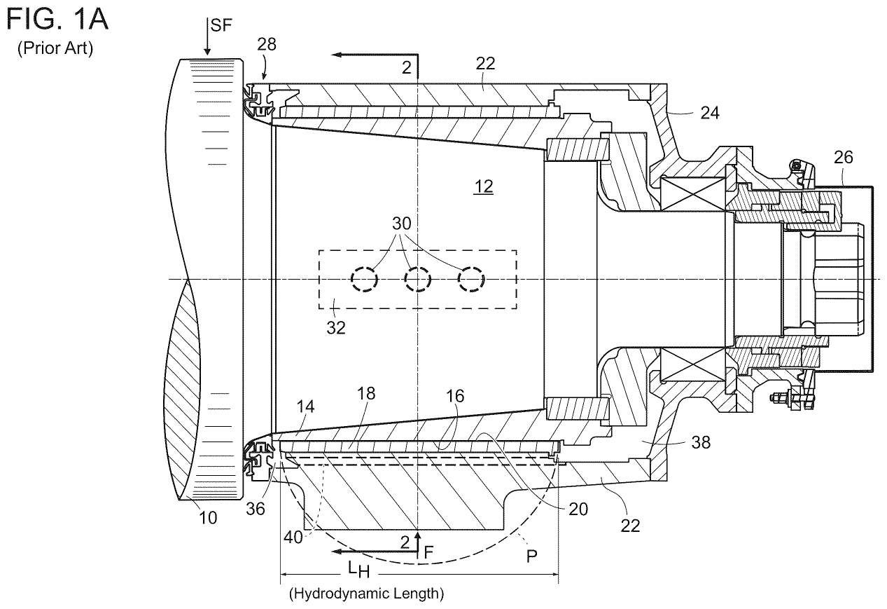

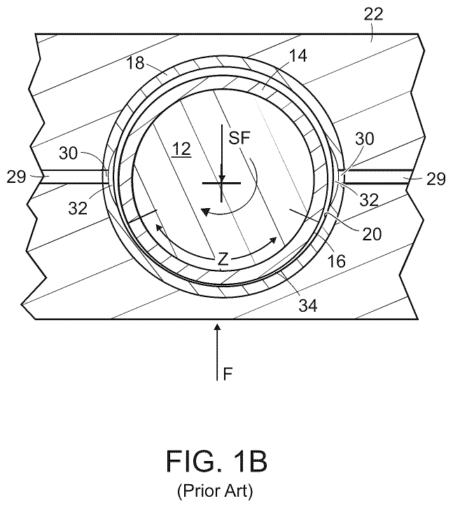

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

Testing of the bearing under various load and speed combinations has shown that the oil film thickness at the inboard side of the bearing (side nearest the roll face) is thinner than that at the outboard end. The difference is typically between 0.05 mm and 0.10 mm. Since the oil film is thinner on the inboard end, the shear rate in the oil film is higher and the bearing and sleeve temperature are also increased.

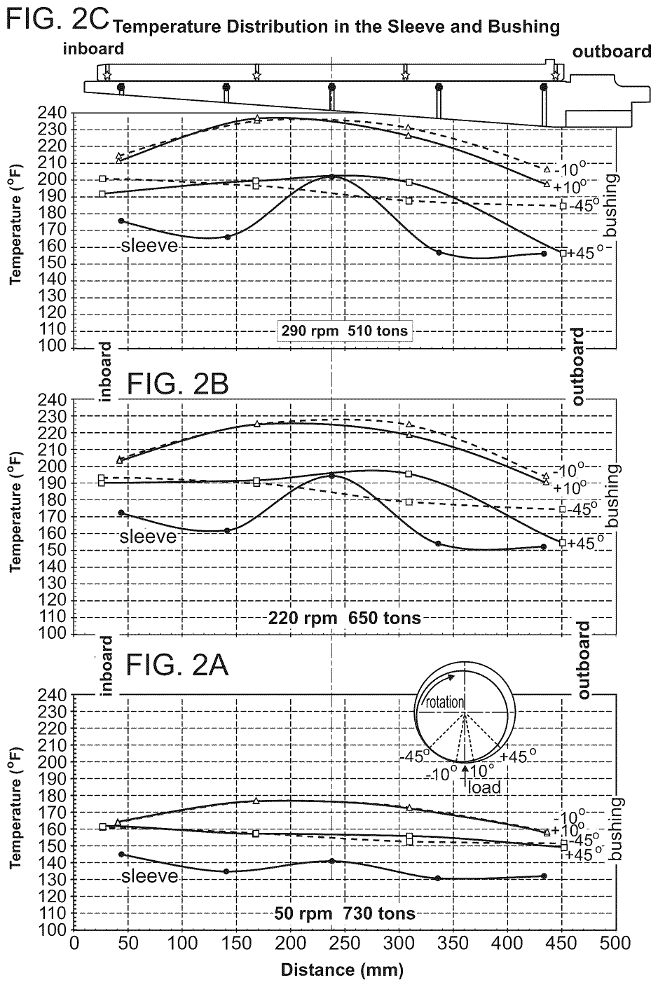

FIGS. 2(A) through 2(C) show graphs of temperature distribution in the sleeve and bushing at the indicated load/speed combinations (i.e., at 50 RPM & 730 tons, 220 RPM & 650 tons, and 290 RPM & 510 tons, respectively). This data was obtained through testing with a full size 30″-75 KL Morgoil hydrodynamic bearing. Thermocouples were installed in the bushing and sleeve. The sleeve had five thermocouples installed in an axial line and since the sleeve rotates the signal was brought out through a slip ring. The fixed bushing has four axial rows of four thermocouples, two rows at +/−10 degrees and two rows at +/−45 degrees from bottom dead center. In the diagram at the top of FIG. 2(C), the bushing thermocouple locations are denoted by a white star and the sleeve thermocouple locations are denoted by a black circle.

It can be seen from FIGS. 2(A) through 2(C) that the temperature at the inboard side of the bushing and sleeve is higher for all load/speed combinations, particularly in the load zone (+/−10 degrees in the bushing) where the film is at its minimum thickness.

Therefore, there is a need to dynamically adjust the film thickness on the inboard end of the bearing, so as the load increases it would be possible to reduce the temperature in that region. This is important as it could reduce a major class of bearing failure called inboard edge wipe.

Prior art is replete with examples that attempt to change the shape of the bearing (static member) to conform to the deformed shape of a shaft or housing. The present invention is different in that the shape of the sleeve and bushing bearing surfaces are not changed in the unloaded condition—in both cases they are cylindrical. Instead, this new concept is to add manufactured features to the sleeve to allow them to deflect as the load increases, but to also control the total deflection. For the purpose of explanation, the desired maximum radial deflection will be calculated as (Bearing Load Rating {F in metric tons}/Hydrodynamic Length {L_{H} in mm})*a wherein a is picked to be in the range 0.02≤a≤0.04 with a preferable 0.025.

The present invention provides a feature of length [symbol] on the tapered inner diameter (ID) of the inboard end of a sleeve (e.g., a sleeve used in a rolling mill). There is a “hinge” feature to allow that inboard end to deflect inward and that total deflection is set by the offset on the end calculated as (Bearing Load Rating {F in metric tons}/Hydrodynamic Length {L_{H} in mm})*a wherein a is picked to be in the range 0.02≤a≤0.04 with a preferable 0.025.

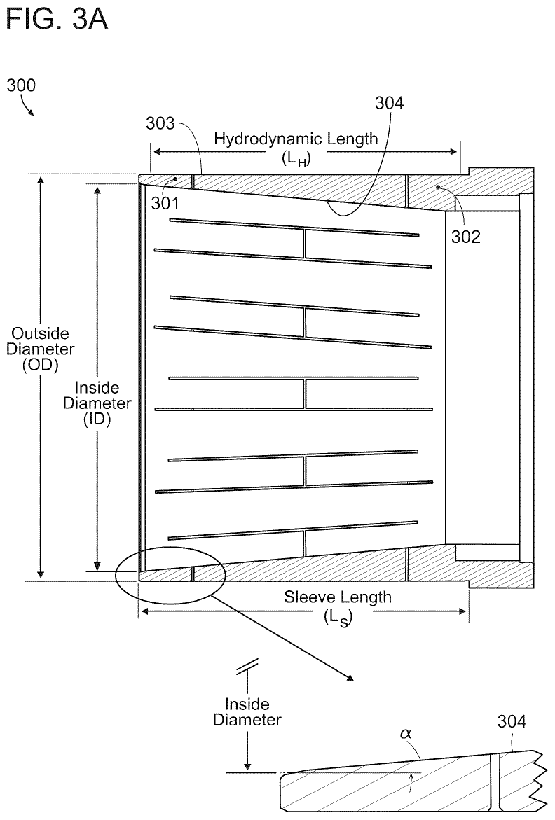

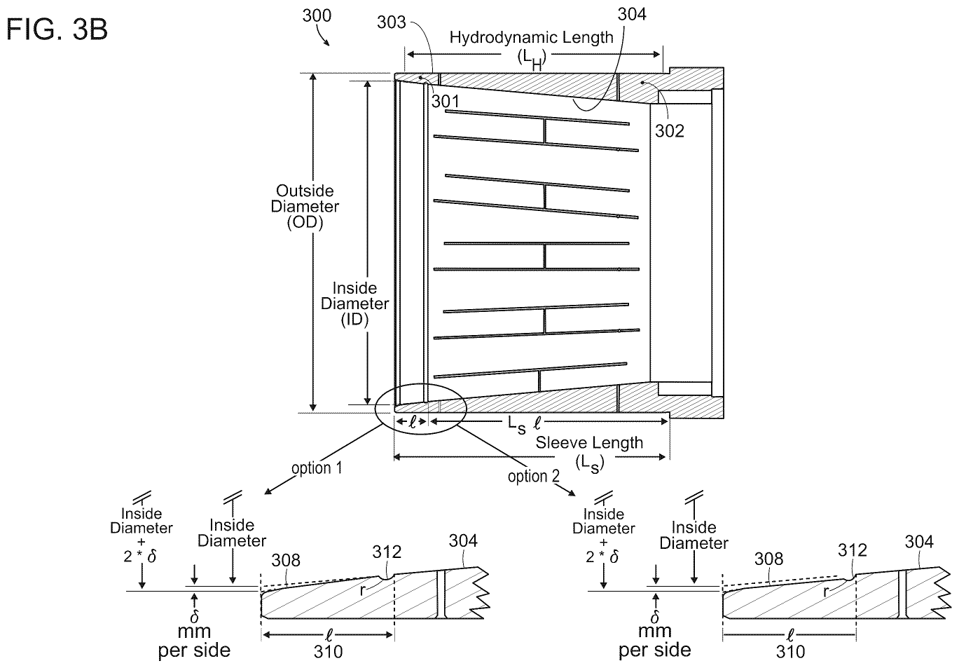

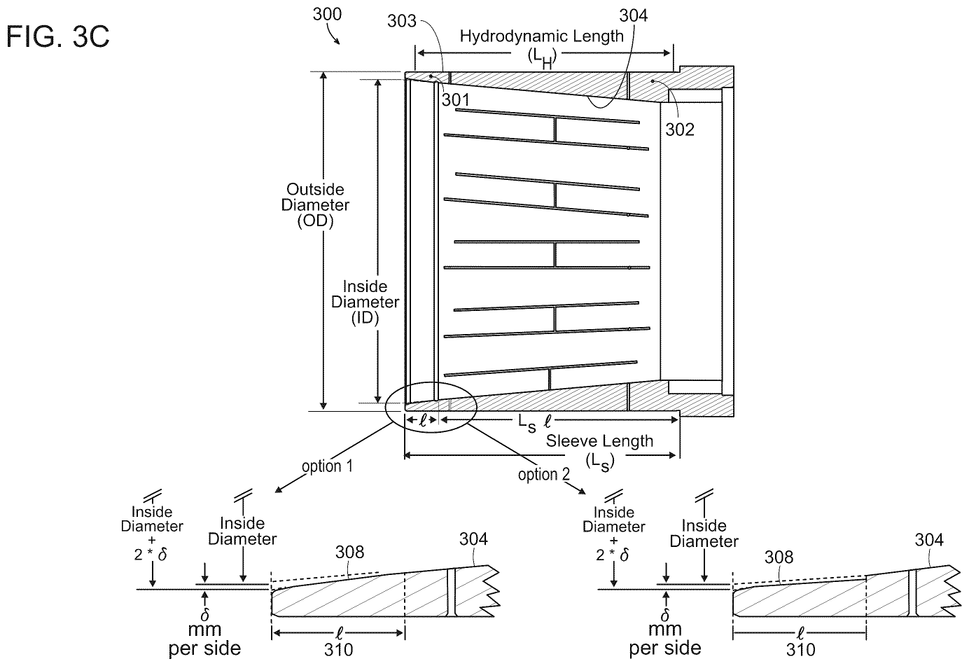

FIG. 3(B) depicts an implementation of the present invention. In one embodiment, FIG. 3(B) option 1, the present invention discloses a sleeve 300 as used on a roll in a rolling mill, the sleeve having an inboard end 301 and an outboard end 302, the sleeve comprising: (a) an outer surface 303 shaped like a cylinder having sleeve length L_{S}, diameter OD, hydrodynamic length L_{H} and outside diameter OD; (b) an inner surface 304 comprised of an inside diameter ID at the inboard end and a taper angle α: (1) a first portion of length (L_{S}−l), the first portion conically shaped having a first ramp portion 304 (which is a portion of the original taper that is part of the inner surface 304); and (2) a second portion of length [symbol] the second portion comprising: (i) an undercut portion 312 located adjacent to an end of the first portion that is proximate to the inboard end, where r, the undercut radius, is preferable defined as 5% of [symbol] 310 the second portion of length) but optionally can be within the range 2% to 10%; (ii) a second ramp portion 308 located adjacent to the undercut portion, wherein the second ramp portion allows the sleeve to deflect as load increases at a maximum radial deflection of δ. Where l is preferably defined as 25%*L_{H} (hydrodynamic length), but optionally can be within the range 20% to 35%. Also, the value for S can be preferably calculated as (Bearing Load Rating {F in metric tons}/Hydrodynamic Length {L_{H} in mm))*a wherein a is picked to be in the range 0.02≤a≤0.04 with a preferable 0.025. Alternately, in FIG. 3(B) option 2, instead of a taper from the hinge 312 to the inboard end, the full length l is undercut by a constant amount δ calculated in the same manner as option 1.

In another embodiment, FIG. 3(C) option 1, the present invention discloses a sleeve 300 as used on a roll in a rolling mill, the sleeve having an inboard end 301 and an outboard end 302, the sleeve comprising: (a) an outer surface 303 shaped like a cylinder having length L_{S} and diameter OD; (b) an inner surface 304 having of an inside diameter ID at the inboard end and a taper angle α, the inner surface comprising: (1) a first portion of length (L_{S}−l), the first portion conically shaped having a first ramp portion 304; and (2) a second portion of length l, the second portion comprising a second ramp portion 308 located adjacent to the first ramp portion 304, wherein the second ramp portion allows the sleeve to deflect as load increases at a maximum radial deflection of δ. Alternately, in FIG. 3(C) option 2, instead of a taper on the second ramp portion 308, the full length [symbol] is undercut by a constant amount δ calculated in the same manner as option 1, above.

The bearing surfaces themselves are cylindrical and deflect under load. That deflection is controllable through manipulating stiffness of the deflection feature. The length l is a function of the hydrodynamic bearing length L_{H}.

In one embodiment, FIG. 3(B) option 1, the present invention provides a sleeve as used in a roll in a rolling mill, the sleeve having an inboard end and an outboard end, the sleeve comprising: (a) an outer surface shaped like a cylinder having sleeve length L_{S}, hydrodynamic length L_{H}, and outside diameter OD, and (b) an inner surface having an inside diameter ID at the inboard end and a taper angle α, the inner surface comprising: (1) a first portion of length (L_{S}−l), the first portion conically shaped having a first ramp portion; and (2) a second portion of length l, the second portion comprising: (i) an undercut portion having an undercut radius, r, the undercut portion located adjacent to an end of the first portion that is proximate to the inboard end; (ii) a second ramp portion located adjacent to the undercut portion, and wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−>length l. In the same embodiment, the undercut radius r is defined as c*length [symbol] wherein c, is picked to be in the range 2%≤c≤10% with c preferable 5%.

In another embodiment, FIG. 3B option 2, the present invention provides a sleeve as used in a roll in a rolling mill, the sleeve having an inboard end and an outboard end, the sleeve comprising: (a) an outer surface shaped like a cylinder having sleeve length L_{S}, hydrodynamic length L_{H} and outside diameter OD; and (b) an inner surface having an inside diameter ID at the inboard end and a taper angle α, the inner surface comprising: (1) a first portion of length (L_{S}−l), the first portion conically shaped having a first ramp portion; and (2) a second portion of length l, wherein the second portion comprises an undercut radius, r, wherein a full length l of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−)>length l. In the same embodiment, the undercut radius r is defined as c*length l wherein c, is picked to be in the range 2%≤c≤10% with c preferable 5%.

In yet another embodiment, FIG. 3(C) option 1, the present invention provides a sleeve as used in a roll in a rolling mill, the sleeve having an inboard end and an outboard end, the sleeve comprising: (a) an outer surface shaped like a cylinder having sleeve length L_{S}, hydrodynamic length L_{H}, and outside diameter OD; (b) an inner surface having of an inside diameter ID at the inboard end and a taper angle α, the inner surface comprising: (1) a first portion of length (L_{S}−l), the first portion conically shaped having a first ramp portion; and (2) a second portion of length l, the second portion comprising a second ramp portion located adjacent to the first ramp portion, wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of [symbol] is defined as b*Hydrodynamic Length {L_{H}}, wherein b is picked to be within the range 20%≤b≤35% with b preferable 25%. In the same embodiment, length (L_{S}−>length.

In another embodiment, FIG. 3(C) option 2, the present invention provides a sleeve as used in a roll in a rolling mill, the sleeve having an inboard end and an outboard end, the sleeve comprising: (a) an outer surface shaped like a cylinder having sleeve length L_{S}, a hydrodynamic length L_{H}, and outside diameter OD; (b) an inner surface having of an inside diameter ID at the inboard end and a taper angle α, the inner surface comprising: (1) a first portion of length (L_{S}−), the first portion conically shaped having a first ramp portion; and (2) a second portion of length, wherein a full length [symbol] of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−>length l.

In yet another embodiment, FIG. 3(B) option 1, the present invention provides a method for lowering temperature build-up on an inboard side of a sleeve, the sleeve used in a roll in a rolling mill, the sleeve having an inboard end and an outboard end, the method comprising: (a) provisioning an outer surface shaped like a cylinder having sleeve length L_{S}, outer diameter OD, and hydrodynamic length L_{H}; and (b) provisioning an inner surface comprising: (1) a first portion of length (L_{S}−l), the first portion conically shaped having a first ramp portion; and (2) a second portion of length l, the second portion comprising: (i) an undercut portion having an undercut radius, r, the undercut portion located adjacent to an end of the first portion that is proximate to the inboard end; (ii) a second ramp portion located adjacent to the undercut portion, and wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a, is picked to be in the range 0.02≤a≤0.04 with a preferable 0.025. In the same embodiment, a value of [symbol] is defined as b*Hydrodynamic Length {L_{H}}, wherein b is picked to be within the range 20%≤b≤35% with b preferable 25%. In the same embodiment, length (L_{S}−)>length l. In the same embodiment, the undercut radius, r, is defined as c*length l wherein c, is picked to be in the range 2%≤c≤10% with c preferable 5%.

In another embodiment, FIG. 3(B) option 2, the present invention provides a method for lowering temperature build-up on an inboard side of a sleeve, the sleeve used in a roll in a rolling mill, the sleeve having an inboard end and an outboard end, the method comprising: (a) provisioning an outer surface shaped like a cylinder having sleeve length L_{S}, hydrodynamic length L_{H} and outside diameter OD; and (b) provisioning an inner surface having of an inside diameter ID at the inboard end and a taper angle α, the inner surface comprising: (1) a first portion of length (L_{S}−l), the first portion conically shaped having a first ramp portion; and (2) a second portion of length l, wherein the second portion comprises an undercut radius, r, wherein a full length l of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−)>length l. In the same embodiment, the undercut radius r is defined as c*length [symbol] wherein c, is picked to be in the range 2%≤c≤10% with c preferable 5%.

In yet another embodiment, FIG. 3(C) option 1, the present invention provides a method for lowering temperature build-up on an inboard side of a sleeve, the sleeve used in a roll in a rolling mill, the sleeve having an inboard end and an outboard end, the method comprising: (a) an outer surface shaped like a cylinder having sleeve length L_{S}, hydrodynamic length L_{H}, and outside diameter OD; (b) an inner surface having of an inside diameter ID at the inboard end and a taper angle α, the inner surface comprising: (1) a first portion of length (L_{S}−l), the first portion conically shaped having a first ramp portion; and (2) a second portion of length l, the second portion comprising a second ramp portion located adjacent to the first ramp portion, wherein the second ramp portion allows the sleeve to deflect as load increases at a maximum radial deflection of δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−)>length l.

In another embodiment, FIG. 3(C) option 2, the present invention provides a method for lowering temperature build-up on an inboard side of a sleeve, the sleeve used in a roll in a rolling mill, the sleeve having an inboard end and an outboard end, the method comprising: (a) provisioning an outer surface shaped like a cylinder having sleeve length L_{S}, a hydrodynamic length L_{H}, and outside diameter OD; (b) provisioning an inner surface having of an inside diameter ID at the inboard end and a taper angle α, the inner surface comprising: (1) a first portion of length (L_{S}−), the first portion conically shaped having a first ramp portion; and (2) a second portion of length l, wherein a full length [symbol] of the second portion is undercut by a constant amount δ. In one embodiment, δ is defined as (Bearing Load Rating {F in metric tons}/Hydrodynamic Length {L_{H} in mm})*a wherein a is picked to be in the range 0.02≤a≤0.04 with a preferable 0.025. In the same embodiment, a value of l is defined as b*Hydrodynamic Length {L_{H}}, wherein b is picked to be within the range 20%≤b≤35% with b preferable 25%. In the same embodiment, length (L_{S}−>length l.

### CONCLUSION

A system and method have been shown in the above embodiments for the effective implementation of a bearing temperature reduction through sleeve modification. While various preferred embodiments have been shown and described, it will be understood that there is no intent to limit the invention by such disclosure, but rather, it is intended to cover all modifications falling within the spirit and scope of the invention, as defined in the appended claims.

1. A sleeve for use in a roll of a rolling mill, the sleeve having an inboard end and an outboard end, the sleeve comprising:
(a) an outer surface shaped like a cylinder having sleeve length L_{S}, hydrodynamic length L_{H}, and outside diameter OD; and
(b) an inner surface having of an inside diameter ID at the inboard end and a taper angle α, the inner surface comprising:
(1) a first portion of length (L_{S}− [symbol] ), the first portion conically shaped having a first ramp portion; and
(2) a second portion of length [symbol] the second portion comprising:
(i) an undercut portion having an undercut radius, r, the undercut portion located adjacent to an end of the first portion that is proximate to the inboard end;
(ii) a second ramp portion located adjacent to the undercut portion, the second ramp portion tapered by an amount δ, and
wherein the second ramp portion allows the sleeve to deflect as load increases at a maximum radial deflection corresponding to the amount δ.

2. (canceled)

3. (canceled)

4. (canceled)

5. (canceled)

6. (canceled)

7. (canceled)

8. (canceled)

9. The sleeve of claim 1, wherein a bushing is disposed around the outer surface of the sleeve, wherein a gap exists between the bushing and the outer surface of the sleeve, the gap configured to maintain a hydrodynamically-maintained oil film.

10. (canceled)

11. (canceled)

12. A sleeve for use in a roll of a rolling mill, the sleeve having an inboard end and an outboard end, the sleeve comprising:
(a) an outer surface shaped like a cylinder having sleeve length L_{S}, hydrodynamic length L_{H}, and outer diameter OD; and
(b) an inner surface an inside diameter ID at the inboard end and a taper angle α, the inner surface comprising:
(1) a first portion of length (L_{S}− [symbol] ), the first portion conically shaped having a first ramp portion; and
(2) a second portion of length [symbol] wherein the second portion comprises an undercut radius, r, the second portion located adjacent to an end of the first portion that is proximate to the inboard end, wherein a full length [symbol] of the second portion is undercut by a constant amount δ.

13. (canceled)

14. (canceled)

15. (canceled)

16. (canceled)

17. (canceled)

18. (canceled)

19. (canceled)

20. A sleeve for use in a roll of a rolling mill, the sleeve having an inboard end and an outboard end, the sleeve comprising:
(a) an outer surface shaped like a cylinder having sleeve length L_{S}, a hydrodynamic length L_{H}, and outside diameter OD;
(b) an inner surface having of an inside diameter ID at the inboard end and a taper angle α, the inner surface comprising:
(1) a first portion of length (L_{S}− [symbol] ) the first portion conically shaped having a first ramp portion; and
(2) a second portion of length l, the second portion comprising a second ramp portion located adjacent to the first ramp portion and the second ramp portion tapered by an amount δ,
wherein the second ramp portion allows the sleeve to deflect as load increases at a maximum radial deflection corresponding to the amount δ,
wherein δ is defined as (Bearing Load Rating {F in metric tons}/Hydrodynamic Length {L_{H} in mm))*a, wherein a is picked to be in the range 0.02≤a≤0.04, wherein a value of [symbol] is defined as b*Hydrodynamic Length {L_{H}), wherein b is picked to be within the range 20%≤b≤35%.

21. (canceled)

22. (canceled)

23. (canceled)

24. A sleeve for use in a roll of a rolling mill, the sleeve having an inboard end and an outboard end, the sleeve comprising:
(a) an outer surface shaped like a cylinder having sleeve length L_{S}, a hydrodynamic length L_{H}, and outside diameter OD;
(b) an inner surface having of an inside diameter ID at the inboard end and a taper angle α, the inner surface comprising:
(1) a first portion of length (L_{S} [symbol] ), the first portion conically shaped having a first ramp portion; and
(2) a second portion of length l, wherein a full length of [symbol] the second portion is undercut by a constant amount δ;
wherein, δ is defined as (Bearing Load Rating {F in metric tons}/Hydrodynamic Length {L_{H} in mm})*a wherein a is picked to be in the range 0.02≤a≤0.04, and wherein a value of [symbol] is defined as b*Hydrodynamic Length {L_{H}}, wherein b is picked to be within the range 20%≤b≤35%.

25. (canceled)

26. (canceled)

27. (canceled)

28. A method for lowering temperature build-up on an inboard side of a sleeve, the sleeve for use in a roll of a rolling mill, the sleeve having an inboard end and an outboard end, the method comprising:
(a) provisioning an outer surface shaped like a cylinder having sleeve length L_{S}, outer diameter OD, and hydrodynamic length L_{H}; and
(b) provisioning an inner surface comprising:
(1) a first portion of length (L_{S}− [symbol] ) the first portion conically shaped having a first ramp portion; and
(2) a second portion of length [symbol] the second portion comprising:
(i) an undercut portion having an undercut radius, r, the undercut portion located adjacent to an end of the first portion that is proximate to the inboard end;
(ii) a second ramp portion located adjacent to the undercut portion, the second ramp portion tapered by an amount δ, and
wherein the second ramp portion allows the sleeve to deflect as load increases at a maximum radial deflection corresponding to the amount δ.

29. (canceled)

30. (canceled)

31. (canceled)

32. (canceled)

33. (canceled)

34. (canceled)

35. A method for lowering temperature build-up on an inboard side of a sleeve, the sleeve for use in a roll of a rolling mill, the sleeve having an inboard end and an outboard end, the method comprising:
(a) provisioning an outer surface shaped like a cylinder having sleeve length L_{S}, hydrodynamic length L, and outside diameter OD; and
(b) provisioning an inner surface having of an inside diameter ID at the inboard end and a taper angle α, the inner surface comprising:
(1) a first portion of length (L_{S}− [symbol] ), the first portion conically shaped having a first ramp portion; and
(2) a second portion of length l, wherein the second portion comprises an undercut radius, r, the second portion located adjacent to an end of the first portion that is proximate to the inboard end, wherein a full length [symbol] of the second portion is undercut by a constant amount.

36. The method of claim 35, wherein δ is defined as (Bearing Load Rating {F in metric tons}/Hydrodynamic Length {L_{H} in mm})*a wherein a is picked to be in the range 0.02≤a≤0.04, and wherein a value of [symbol] is defined as b*Hydrodynamic Length {L_{H}}, wherein b is picked to be within the range 20%≤b≤35%.

37. (canceled)

38. (canceled)

39. (canceled)

40. (canceled)

41. (canceled)

42. A method for lowering temperature build-up on an inboard side of a sleeve, the sleeve for use in a roll of a rolling mill, the sleeve having an inboard end and an outboard end, the method comprising:
(a) provisioning an outer surface shaped like a cylinder having sleeve length L_{S}, hydrodynamic length L_{H}, and outside diameter OD; (b) an inner surface having an inside diameter ID at the inboard end and a taper angle α, the inner surface comprising: (1) a first portion of length (L_{S}− [symbol] ), the first portion conically shaped having a first ramp portion; and
(2) a second portion of length [symbol] the second portion comprising a second ramp portion located adjacent to the first ramp portion, the second ramp portion tapered by an amount δ, wherein the second ramp portion allows the sleeve to deflect as load increases at a maximum radial deflection corresponding to the amount δ.

43. The method of claim 42, wherein δ is defined as (Bearing Load Rating {F in metric tons}/Hydrodynamic Length {L_{H} in mm})*a wherein a is picked to be in the range 0.02≤a≤0.04, and a value of [symbol] is defined as b*Hydrodynamic Length {L_{H}}, wherein b is picked to be within the range 20%≤b≤35%.

44. (canceled)

45. (canceled)

46. (canceled)

47. A method for lowering temperature build-up on an inboard side of a sleeve, the sleeve for use in a roll of a rolling mill, the sleeve having an inboard end and an outboard end, the method comprising:
(a) provisioning an outer surface shaped like a cylinder having sleeve length L_{S}, a hydrodynamic length L_{H}, and outside diameter OD;
(b) provisioning an inner surface having of an inside diameter ID at the inboard end and a taper angle α, the inner surface comprising:
(1) a first portion of length (L_{S}− [symbol] ), the first portion conically shaped having a first ramp portion; and
(2) a second portion of length l, wherein a full length [symbol] of the second portion is undercut by a constant amount δ.

48. The method of claim 47, wherein δ is defined as (Bearing Load Rating {F in metric tons}/Hydrodynamic Length {L_{H} in mm})*a wherein a is picked to be in the range 0.02≤a≤0.04, and a value of [symbol] is defined as b*Hydrodynamic Length {L_{H}}, wherein b is picked to be within the range 20%≤b≤35%.

49. (canceled)

50. (canceled)

51. (canceled)
